(19) United States
(12) Patent Application Publication
(10) Pub. No.: US 2007/0022128 A1
(43) Pub. Date: Jan. 25, 2007

(54) Structuring data for spreadsheet documents

(75) Inventors: Chad B. Rothschiller, Edmonds, WA (US); Eoin J. Burke, Seattle, WA (US); Noah R. Chen, Bellevue, WA (US); Robert R. McCaughey, Sammamish, WA (US); Su-Piao B. Wu, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/389,367

(22) Filed: Mar. 24, 2006

Related U.S. Application Data
(60) Provisional application No. 60/687,056, filed on Jun. 3, 2005.
(60) Provisional application No. 60/716,782, filed on Sep. 13, 2005.

(51) Int. Cl. G06F 7/00

(52) U.S. Cl. 707/100

(57) ABSTRACT

An open file format is used to represent the features and data associated with a spreadsheet application within a document. The file format simplifies the way a spreadsheet application organizes document features and data, and presents a logical model that is easily accessible. The file format is made up of a collection of modular parts that are stored within a container. The modular parts are logically separate but are associated with one another by one or more relationships. Each of the modular parts is capable of being interrogated separately regardless of whether or not the application that created the document is running. Each modular part is capable of having information extracted from it and copied into another document and reused. Information may also be changed, added, and deleted from each of the modular parts.

### RELATED APPLICATIONS

This utility patent application claims the benefit under 35 United States Code § 19(e) of U.S. Provisional Patent Application No. 60/687,056 filed on Jun. 3, 2005 and U.S. Provisional Patent Application No. 60/716,782 filed on Sep. 13, 2005, which are both hereby incorporated by reference in their entirety.

### REFERENCE TO COMPUTER PROGRAM LISTING APPENDIX

The following compact disc submission includes two compact discs each having identical ASCII text files in the IBM-PC machine format and are compatible for reading with MS-DOS and MS-WINDOWS operating systems. The computer program listing files submitted on the compact discs are incorporated herein by reference in their entirety as if set forth in full in this document for all purposes: NAME SIZE (KB) CREATION DATE: xlautofilter.txt 8 KB Jan. 30, 2006; xlbasictypes.txt 2 KB Jan. 23, 2006; xlcalcchain.txt 2 KB Dec. 12, 2005; xlcomments.txt 2 KB Feb. 13, 2006; xldr.txt 6 KB Feb. 07, 2006; xldrDrs.txt 1 KB Dec. 12, 2005; xlextconns.txt 9 KB Jan. 17, 2006; xlmetadata.txt 6 KB Feb. 01, 2006; xlPivot.txt 37 KB Feb. 13, 2006; xlpivotshared.txt 4 KB Jan. 09, 2006; xlqsi.txt 4 KB Jan. 23, 2006; xlrcvr.txt 2 KB Feb. 04, 2006; xlsheet.txt 37 KB Feb. 13, 2006; xlshrrev.txt 10 KB Feb. 13, 2006; xlshrusr.txt 2 KB Jan. 31, 2006; xlsingleCells.txt 2 KB Jan. 31, 2006; xlsst.txt 4 KB Jan. 30, 2006; xlstyles.txt 16 KB Feb. 13, 2006; xlsupbook.txt 4 KB Feb. 13, 2006; xltable.txt 6 KB Jan. 31, 2006; xlvoldeps.txt 3 KB Jan. 11, 2006; xlworkbook.txt 14 KB Feb. 13, 2006; and xlxmlMaps.txt 2 KB Feb. 02, 2006.

### BACKGROUND

Developers looking to manipulate the content of a document have to know how to read and write data according to the file format of the document. This process can be complex and challenging. Attempting to alter a document programmatically without using the associated application has been identified as a leading cause of file corruption, and has deterred many developers from even attempting to try to make alterations to the files, create new ones from scratch, or read data from existing files. These documents are also stored in file formats that are typically proprietary. As such, each company that creates a file may utilize a different file format. Accessing the information that is contained within a proprietary format can be next to impossible because the data format is usually not public material. Reusing information between different applications can also be very difficult. Special code is usually required to be written to create reader and writer classes that can handle extracting and locating information within the proprietary file formats.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An open file format is used to represent the features and data associated with a spreadsheet application within a document. The open file format is directed at simplifying the way a spreadsheet application organizes document features and data, and presents a logical model that is easily accessible. A document structured according to the open file format is designed such that it is made up of a collection of modular parts that are stored within a container. The modular parts are logically separate but are associated with one another by one or more relationships. Each of the modular parts is capable of being interrogated separately regardless of whether or not the application that created the document is running. Each modular part is capable of having information extracted from it and copied into another document and reused. Information may also be changed, added, and deleted from each of the modular parts. Common data, such as strings, functions, etc., may be stored in their own modular part such that the document does not contain excessive amounts of redundant data. Additionally, code, personal information, comments, as well as any other determined information may be stored in a separate modular part such that the information may be easily parsed and/or removed from the document.

These and various other features, as well as other advantages, will be apparent from a reading of the following detailed description and a review of the associated drawings.

### BRIEF DESCRIPTION OF THE DRAWINGS

FIG. 1 illustrates an exemplary computing device that may be used in exemplary embodiments of the present invention;

FIG. 2 shows an exemplary document container with modular parts;

FIG. 3 shows a high-level relationship diagram of a spreadsheet workbook within a container;

FIGS. 4A-4G illustrate a document relationship hierarchy for various modular parts utilized in a file format for representing a spreadsheet document; and

FIGS. 5-6 are illustrative routines performed in representing spreadsheet documents in a modular content framework, in accordance with aspects of the invention.

### DETAILED DESCRIPTION

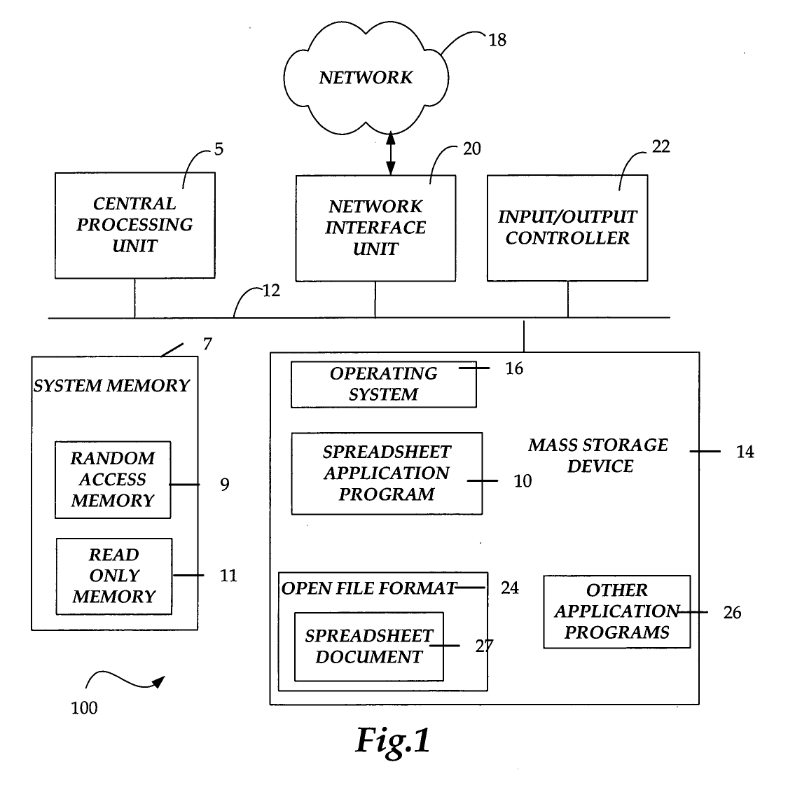

Referring now to the drawings, in which like numerals represent like elements, various aspects will be described herein. In particular, FIG. 1 and the corresponding discussion are intended to provide a brief, general description of a suitable computing environment in which embodiments of the invention may be implemented. While the invention will be described in the general context of program modules that execute in conjunction with program modules that run on an operating system on a personal computer, other types of computer systems and program modules may be used.

Generally, program modules include routines, programs, operations, components, data structures, and other types of structures that perform particular tasks or implement particular abstract data types. Moreover, other computer system configurations, including hand-held devices, multiprocessor systems, microprocessor-based or programmable consumer electronics, minicomputers, mainframe computers, and the like may be used. A distributed computing environment where tasks are performed by remote processing devices that are linked through a communications network may also be utilized. In a distributed computing environment, program modules may be located in both local and remote memory storage devices.

Referring now to FIG. 1, an illustrative computer architecture for a computer 100 will be described. The computer architecture shown in FIG. 1 illustrates a computing apparatus, such as a server, desktop, laptop, or handheld computing apparatus, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 100 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVJS'), or other optical storage, magnetic cassettes, magnetic tape, magnetic disk storage or other magnetic storage devices, or any other medium which can be used to store the desired information and which can be accessed by the computer 100.

The computer 100 may operate in a networked environment using logical connections to remote computers through a network 18, such as the Internet. The computer 100 may connect to the network 18 through a network interface unit 20 connected to the bus 12. The network interface unit 20 may also be utilized to connect to other types of networks and remote computer systems. The computer 100 may also include an input/output controller 22 for receiving and processing input from a number of other devices, including a keyboard, mouse, or electronic stylus (not shown). Similarly, an input/output controller 22 may provide output to a display screen, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS XP operating system from MICROSOFT CORPORATION of Redmond, Wash. The mass storage device 14 and RAM 9 may also store one or more program modules. In particular, the mass storage device 14 and the RAM 9 may store a spreadsheet application program 10. The spreadsheet application program 10 is operative to provide functionality for the creation and structure of a spreadsheet document, such as a document 27, in an open file format 24. According to one embodiment, the spreadsheet application program 10 and other application programs 26 comprise the OFFICE suite of application programs from MICROSOFT CORPORATION including the WORD, EXCEL, and POWERPOINT application programs.

The open file format 24 simplifies and clarifies the organization of document features and data. The spreadsheet program 10 organizes the ‘parts’ of a document (sheets, styles, strings, document properties, application properties, custom properties, functions, and the like) into logical, separate pieces, and then expresses relationships among the separate parts. These relationships, and the logical separation of ‘parts’ of a document, make up a file organization that can be easily accessed without having to understand a proprietary format.

The open file format 24 may be formatted according to extensible markup language (“XML”). XML is a standard format for communicating data. In the XML data format, a schema is used to provide XML data with a set of grammatical and data type rules governing the types and structure of data that may be communicated. The modular parts may also be included within a container. According to one embodiment, the modular parts are stored in a container according to the ZIP format. Additionally, since the open file format 24 is expressed as XML, formulas within a spreadsheet are represented as standard text making them easy to locate as well as modify.

Documents that follow the open file format 24 are programmatically accessible both while the spreadsheet program 10 is running and not running. This enables a significant number of new uses that were simply too hard to accomplish using the previous file formats. For instance, a server-side program is able to create a document based on input from a user, back-end server data, or some other source. With the industry standard XML at the core of the open file format, exchanging data between applications created by different businesses is greatly simplified. Without requiring access to the application that created the document, solutions can alter information inside a document or create a document entirely from scratch by using standard tools and technologies capable of manipulating XML. The open file format has been designed to be more robust than the binary formats, and, therefore, reduces the risk of lost information due to damaged or corrupted files. Even documents created or altered outside of the creating application are less likely to corrupt, as programs that open the files may be configured to verify the parts of the document.

The openness of the open file format also translates to more secure and transparent files. Documents can be shared confidently because personally identifiable information and business sensitive information, such as user names, comments and file paths, can be easily identified and removed from the document. Similarly, files containing content, such as OLE objects or Visual Basic® for Applications (VBA) code can be identified for special processing.

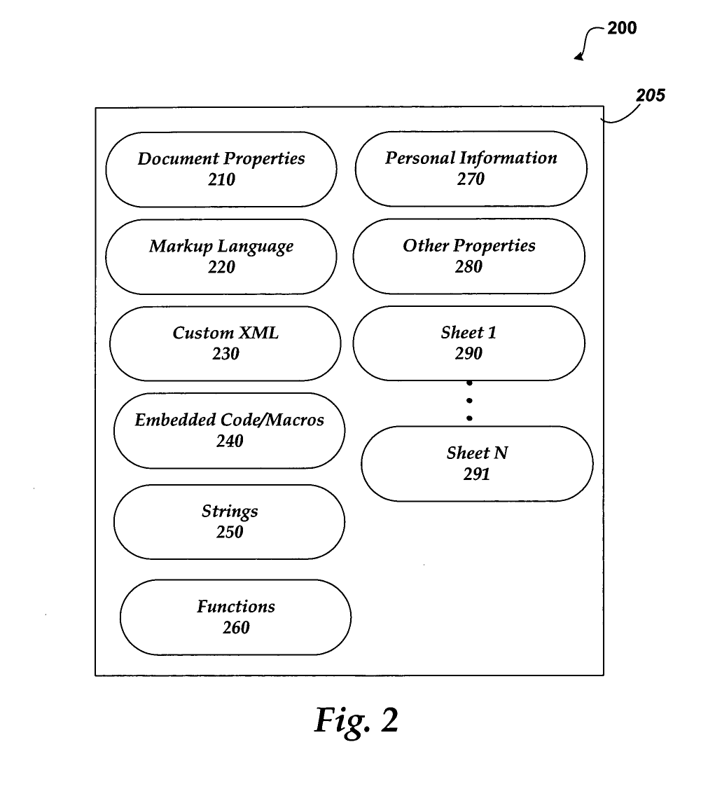

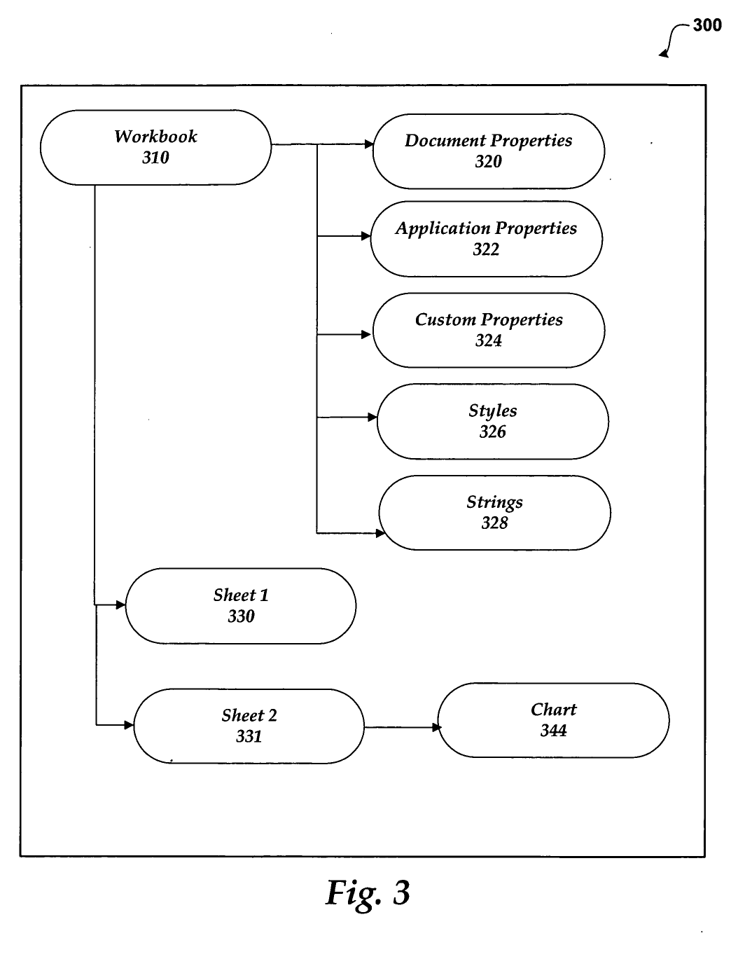

FIG. 2 shows an exemplary document container with modular parts. As illustrated, document container 200 includes document properties 210, markup language 220, custom-defined XML 230, embedded code/macros 240, strings 250, functions 260, personal information 270, other properties 280, and sheets 1 (290) through sheet N (291) that are associated with a workbook (See FIG. 3 and related discussion).

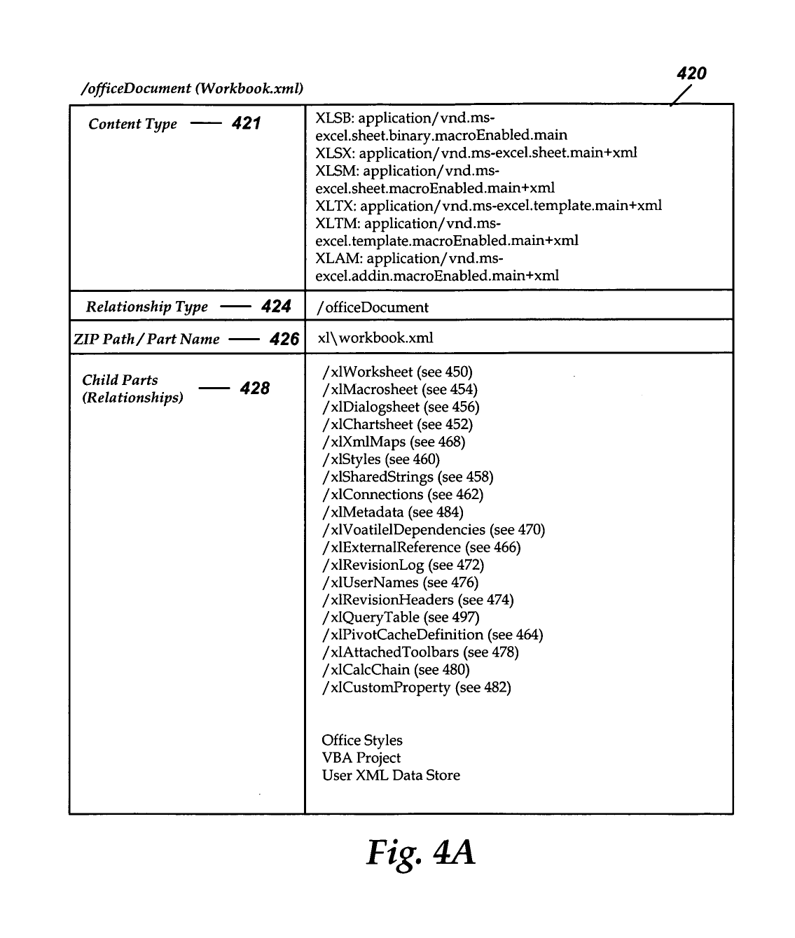

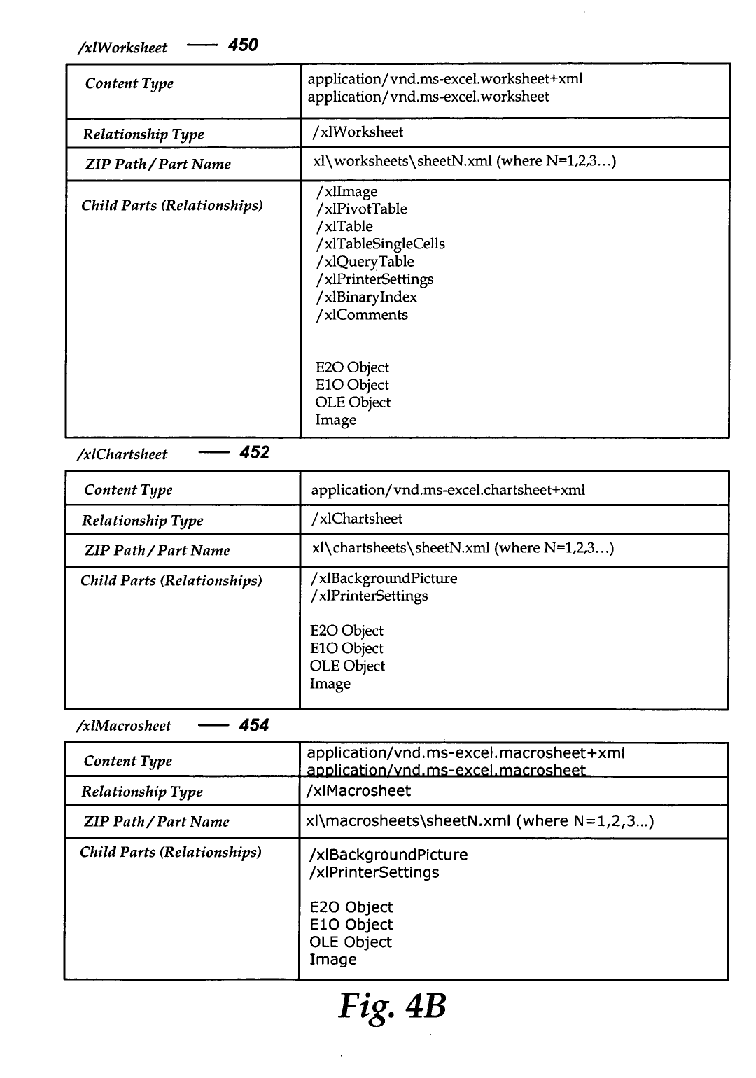

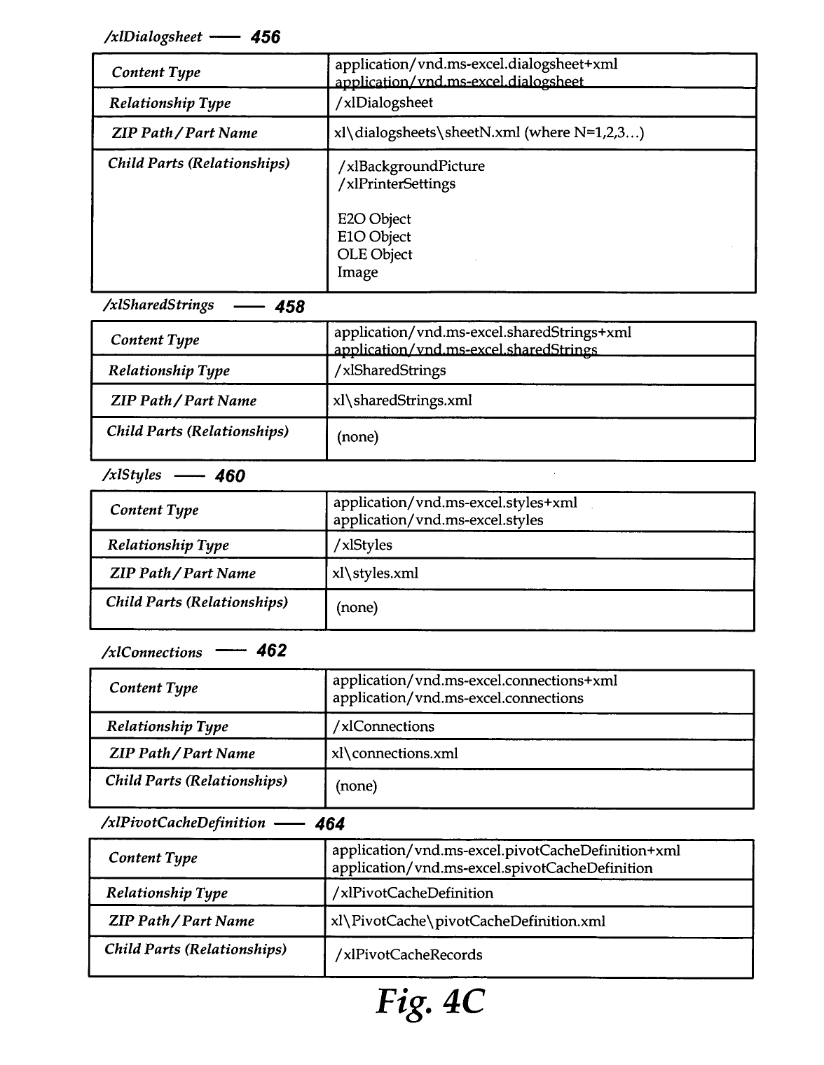

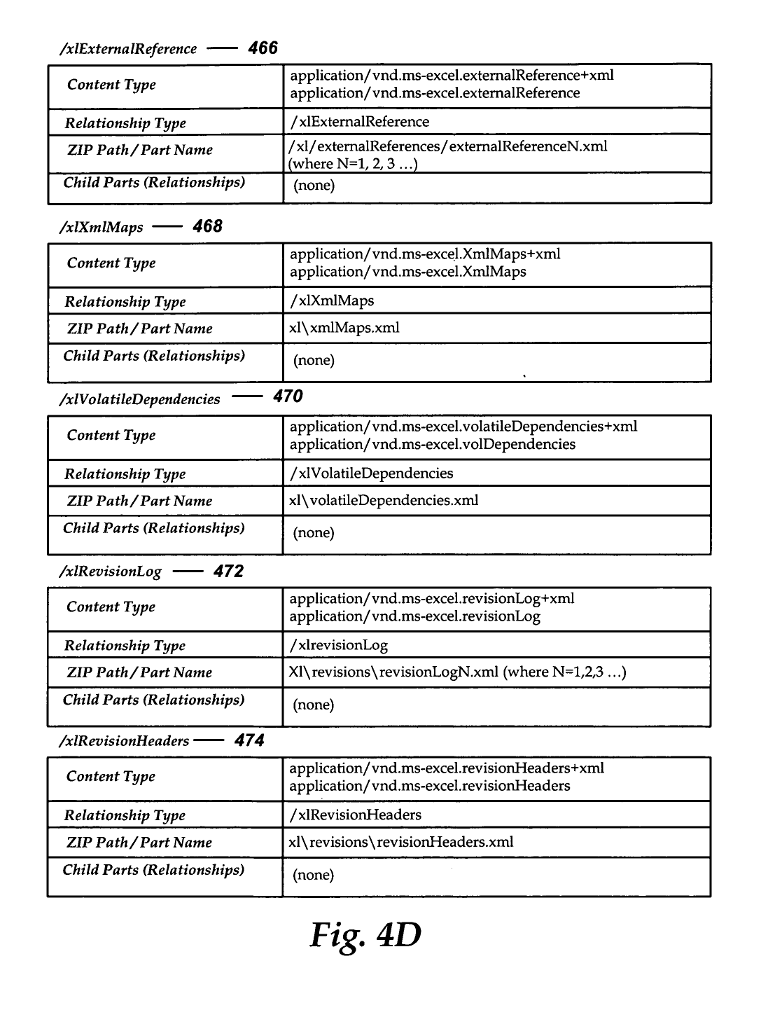

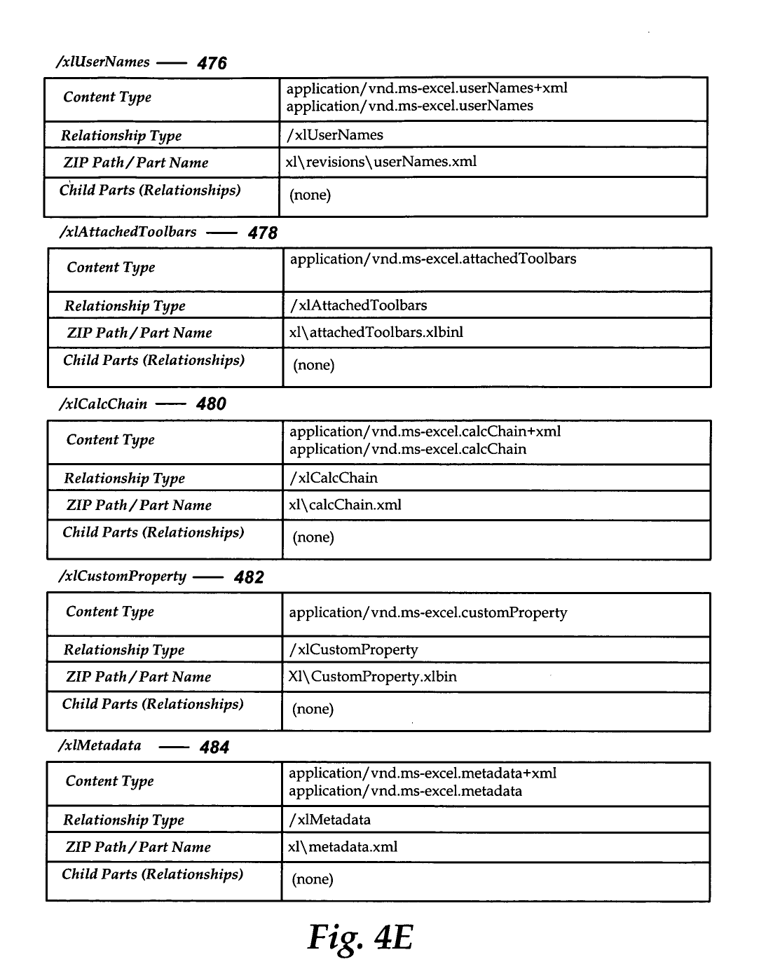

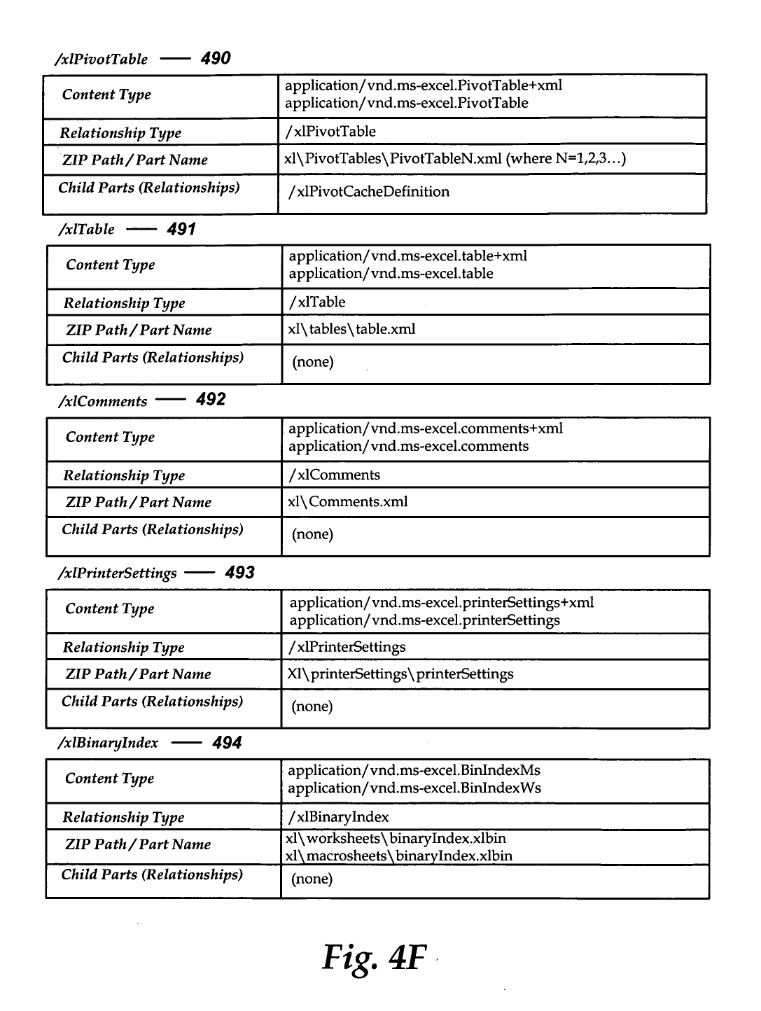

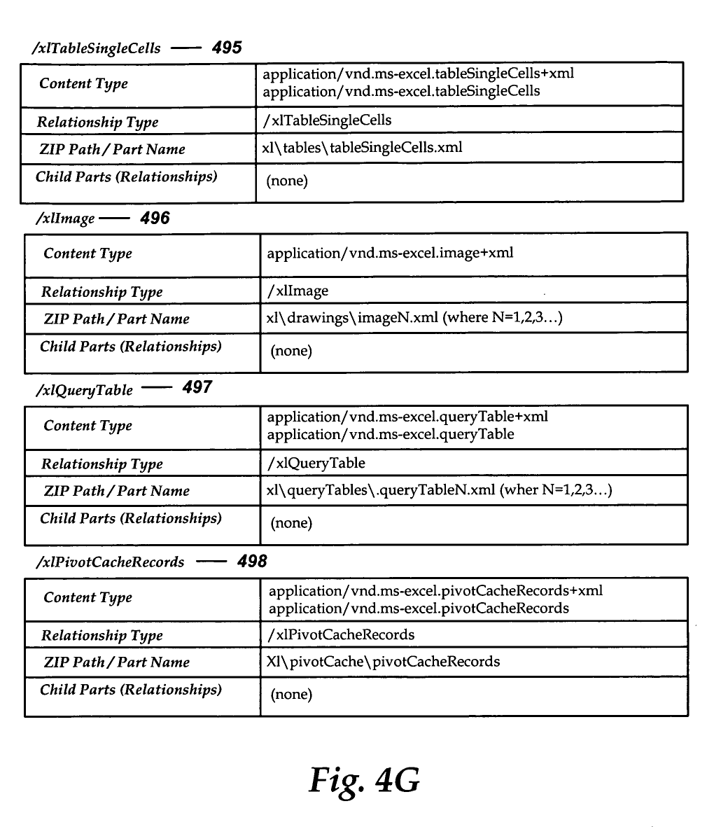

Each modular part (210-291) is enclosed by container 205. According to one embodiment, the container is a ZIP container. The combination of XML with ZIP compression allows for a very robust and modular format that enables a large number of new scenarios. Each file may be composed of a collection of any number of parts that defines the document. Most of the modular parts making up the document are XML files that describe application data, metadata, and even customer data stored inside the container 205. Other non-XML parts may also be included within the container, and include such parts as binary files representing images or OLE objects embedded in the document. Parts of the document specify a relationship to other parts (See FIG. 4 and related discussion). While the parts make up the content of the file, the relationships describe how the pieces of content work together. The result is an open file format for documents that is tightly integrated but modular and highly flexible.

There are many elements that go into creating a spreadsheet document. Some of the parts may be commonly shared across applications, such as document properties, styles, charts, hyperlinks, comments, annotations, and the like. Other parts, however, may be specific to each application.

When users save or create a document, container 205 is stored as a single file on the computer disk. The container 205 may then easily be opened by any application that can process XML. By wrapping the individual parts of a file in a container 205, each document remains a single file instance. Once a container 205 has been opened, developers can manipulate any of the modular parts (210-291) that are found within the container 205 that define the document. For instance, a developer can open a spreadsheet document container that uses the open file format, locate the XML part that represents a particular portion of the spreadsheet, such as sheet 1, alter the part corresponding to sheet 1 (290) by using any technology capable of editing XML, and return the XML part to the container package 205 to create an updated spreadsheet document. This scenario is only one of the essentially countless others that will be possible as a result of open format.

The modularity of the parts making up the document enables a developer to quickly locate a specific part of the file and work directly with just that part. The individual parts can be edited, exchanged, or even removed depending on the desired outcome of a specific business need. The modular parts can be of different physical content types. According to one embodiment, the parts used to describe program data are stored as XML. These parts conform to the XML reference schema(s) (220, 230) that defines the associated feature or object. For example, in a spreadsheet file, the data that represents a worksheet is found in an XML part that adheres to the schema for a Spreadsheet Worksheet. Additionally, when there were multiple worksheets in the workbook there is a corresponding XML part stored in the container file for each worksheet (See Sheet 1 (390) through Sheet N (392)).

The schemas that represent parts of documents are fully documented and made available such that other applications may use them. Then, by using any standard XML based technologies, developers can apply their knowledge of the schemas to easily parse and create a document that is associated with a specific application. For example, a spreadsheet document could be created for MICROSOFT EXCEL without having to use MICROSOFT EXCEL to create or open the document. Although the schemas included as part of this application are quite extensive, in order to fully represent the rich feature sets that the MICROSOFT EXCEL and OFFICE programs provide, all structures defined by the format are not required to generate a document. Applications are quite capable of opening the file with a minimal amount of items defined, thereby making it easy to create many documents. The XML reference schemas govern how data is stored, including, but not limited to: display-oriented attributes; document formatting; numbers; strings; formulas; calculations, and the like. Customer-defined schemas define items such as data-oriented structures that represent the business information stored within the document, and can be unique to a particular business or industry.

In some instances, it is advantageous to have the modular parts stored in their native content type. For example, images may be stored as binary files (.png, jpg, and so on) within the container 205. Therefore, the container 205 may be opened by using a ZIP utility and the image may then be immediately viewed, edited, or replaced in its native format. Not only is this storage approach more accessible, but it requires less internal processing and disk space than storing an image as encoded XML. Other example parts that may be stored natively as binary parts include VBA projects and embedded OLE objects. Obviously, many other parts may also be stored natively. For developers, accessibility makes many scenarios more attractive. For instance, a developer could implement a solution that iterates a collection of spreadsheet documents to update an existing value/string/function with an updated value/string/function.

Security is very important today in information technology. The open file format allows developers to be more confident about working with documents and delivering solutions that take document security into full account. With the open file format, developers can more easily build solutions that search for and remove any identified, potential vulnerabilities, such as embedded code/macros 240 before they cause issues (harm to the user's computer system or a network of computer systems).

For example, assume a company needs a solution to prepare documents either for storage in an archive library where they would never need to run custom code, or for sending macro-free documents to a customer. An application could be written that removes all VBA code from a body of documents by iterating through the documents and removing the [vbaProject.bin] part and its corresponding relationship. The result would be a collection of documents that do not contain executable VBA code. Other code that is a security risk may also be removed. Code that is included within documents, however, is not the only potential security threat. Developers & organizations can circumvent potential risks from binaries, such as OLE objects or even images, by interrogating the documents and removing any exposures that arise. For example, if a specific OLE object is identified as a known issue, a program could be created to locate and cleanse or quarantine any documents containing the object. Likewise, any external references being made from a document can be readily identified. This identification allows solution developers to decide if external resources being referenced from a document are trustworthy, private, personally identifiable, or require corrective action.

As programs seek to protect users from malicious content, developers can also help protect users from accidentally sharing data inappropriately. This protection might be in the form of personally identifiable information 270 stored within a document, or comments and annotations that information so marked shouldn't leave the department or organization. Developers can programmatically remove both types of information directly without having to parse an entire document. To remove document comments, for example, a developer can check for the existence of a comment part relationship and, if found, remove the associated comment part.

Besides securing the personal information and comments, the open file format enables access to this information that may be useful in other ways. A developer may create a solution that uses the personal information 270 to return a list of documents authored by an individual person or from a specific organization. This list can be produced without having to open an application or use its object model with the open file format. Similarly, an application could loop through a folder or volume of documents and aggregate all of the comments within the documents. Additional criteria could be applied to qualify the comments and help users better manage the collaboration process as they create documents. This transparency helps increase the trustworthiness of documents and document-related processes by allowing programs or users to verify the contents of a document without opening the file. The open file format enables users or applications to see and identify the various parts of a file and to choose whether to load specific components. For example, a user can choose to load the document content without loading the macro code. In particular, the ability to identify and handle embedded code 240 supports compliance management and helps reduce security concerns around malicious document code.

Likewise, personally identifiable or business-sensitive information (270) (for example, comments, deletions, user names, file paths, and other document metadata) can be clearly identified and separated from the document data. As a result, organizations can more effectively enforce policies or best practices related to security, privacy, and document management, and they can exchange documents more confidently.

FIG. 3 shows a high-level relationship diagram of a spreadsheet workbook within a container. As illustrated, the exemplary container 300 includes workbook 310, two sheets (sheet 1 (330) and sheet 2 (331)), document properties 320, application properties 322, custom properties 324, styles 326 and strings 328. Each sheet may include a reference to chart 344. Many other configurations of the modular parts and the relationships may be defined. For example, referring to FIGS. 4A-4G which provides more detail regarding relationships among modular parts, it can be seen that a spreadsheet document may include many more modular parts and relationships. Whereas the parts are the individual elements that make up a document, the relationships are the method used to specify how the collection of parts come together to form the actual document. The relationships are defined by using XML, which specifies the connection between a source part and a target resource. For example, the connection between a sheet and a string that appears in that sheet is identified by a relationship. The relationships are stored within XML parts or “relationship parts” in the document container 300. If a source part has multiple relationships, all subsequent relationships are listed in same XML relationship part. Each part within the container is referenced by at least one relationship. The implementation of relationships makes it possible for the parts never to directly reference other parts, and connections between the parts are directly discoverable without having to look within the content. Within the parts, the references to relationships are represented using a Relationship ID, which allows all connections between parts to stay independent of content-specific schema.

The following is one example of a relationship part in a workbook containing two worksheets:

<Relationships xmlns=“ . . . /relationships”>
<Relationship ID=“rId3”

Type=“ . . . /relationships/xlStyles”

Target=“styles.xml”/>

<Relationship ID=“rId2”
Type=“ . . . /relationships/xlWorksheet”

Target=“worksheets/Sheet2.xml”/>

<Relationship ID=“rId1”

Type=“ . . . /relationships/xlWorksheet”

Target=“worksheets/Sheet1.xml”/>

<Relationship ID=“rId5”
Type=“ . . . /relationships/xlMetadata”

Target=“metadata.xml”/>

<Relationship ID=“rId4”

Type=“ . . . /relationships/xlSharedStrings”

Target=“strings.xml”/>

</Relationships>

The relationships may represent not only internal document references but also external resources. For example, if a document contains linked pictures or objects, these are represented using relationships as well. This makes links in a document to external sources easy to locate, inspect and alter. It also offers developers the opportunity to repair broken external links, validate unfamiliar sources or remove potentially harmful links.

The use of relationships in the open file format benefits developers in a number of ways. Relationships simplify the process of locating content within a document. The documents parts don't need to be parsed to locate content whether it is internal or external document resources. Relationships also allow a user to quickly take inventory of all the content within a document. For example, if the number of worksheets in a spreadsheet workbook needed to be counted, the relationships could be inspected to determine how many sheet parts exist within the container. The relationships may also be used to examine the type of content in a document. This is helpful in instances where there is a need to identify if a document contains a particular type of content that may be harmful, such as an OLE object that is suspect, or helpful, as in a scenario where there is a desire to extract all JPEG images from a document for re-use elsewhere. Additionally, relationships allow developers to manipulate documents without having to learn application specific syntax or content markup. For example, without any knowledge of how to program a spreadsheet application, a developer solution could easily remove a sheet by editing the document's relationships.

According to one embodiment, documents saved in the open file format are considered to be macro-free files and therefore do not contain code. This behavior helps to ensure that malicious code residing in a default document can never be unexpectedly executed. While documents can still contain and use macros, the user or developer specifically saves these documents as a macro-enabled document type. This safeguard does not affect a developer's ability to build solutions, but allows organizations to use documents with more confidence.

Macro-enabled files have the same file format as macro-free files, but contain additional parts that macro-free files do not. Macro-enabled files also have a different content type which specifically indicates a macro-enabled file, and use a different file extension. The additional parts depend on the type of automation found in the document. A macro-enabled file that uses VBA contains a binary part that stores the VBA project. Any workbook that utilizes macros such as XLM macros they may be saved as macro-enabled files. If a code-specific part is found in a macro-free file, whether placed there accidentally or maliciously, an application may be configured to not allow the code to execute, or may decide to not open the entire file, at all.

Since any code that is associated with a document is stored as a modular part, developers can now determine if any code exists within a document before opening it. Previously this advance notice wasn't something that could be easily accomplished. Now the developer can inspect the container for the existence of any code-based parts and relationships without running the corresponding application and potentially risky code. If a file looks suspicious, a developer can remove any parts capable of executing code from the file.

Documents saved by using the open file format may be identified by their file extensions. According to one embodiment, the extensions borrow from existing binary file extensions by appending a letter to the end of the suffix. The default extensions for documents created in MICROSOFT WORD, EXCEL, and POWERPOINT using the open file format append the letter “x” to the file extension resulting in .docx, .xlsx, and .pptx, respectively. The file extensions may also indicate whether the file is macro-enabled versus those that are macro-free. Documents that are macro-enabled have a file extension that ends with the letter “m” instead of an “x.” For example, a macro-enabled spreadsheet document has a .xlsx extension, and thereby allows any users or software program, before a document opens, to immediately identify that it might contain code.

As discussed above, most parts of a document within a container can be manipulated using any standard XML processing techniques, or for the modular parts of the document that exist as embedded native formats, such as images, they may be processed using any appropriate tool for that object type. Once inside an open document, the structure makes it easy to navigate a document's parts and its relationships, whether it is to locate information, change content, or remove elements from a document. Having the use of XML, along with the published reference schemas, means a user can easily create new documents, add data to existing documents, or search for specific content in a body of documents.

The following are exemplary scenarios in which the open file format enables document-based solutions. These are only a few of an almost endless list of possibilities: Data Interoperability; Content Manipulation; Content Sharing and Reuse; Document Assembly; Document Creation, Document Security; Managing Sensitive Information; Document Styling; and Document Profiling. The openness of the open file format unlocks data and introduces a broad, new level of integration beyond the desktop. For example, developers may refer to the published specification of the new file format to create data-rich documents without using the application that created the document. Server-side applications may process documents in bulk to enable large-scale solutions that mesh enterprise data within a familiar application. Standard XML protocols, such as XPath (a common XML query language) and XSLT (Extensible Stylesheet Language Transformations), can be used to retrieve data from documents or to update the contents inside of a document from external data.

One such scenario could involve personalizing thousands of documents to distribute to customers. Information programmatically extracted from an enterprise database or customer relationship management (CRM) application could be inserted into a standard document template by a server application that uses XML. Creating these documents is highly efficient because there is no requirement that the creating programs need to be run; yet the capability still exists for producing high-quality, rich documents.

The use of custom schemas in one or more applications is another way documents can be leveraged to share data. Information that was once locked in a binary format is now easily accessible and therefore, documents can serve as openly exchangeable data sources. Custom schemas not only make insertion or extraction of data simple, but they also add structure to documents and are capable of enforcing data validation.

Editing the contents of existing documents is another valuable example where the open file format enhances a process. The edit may involve updating small amounts of data, swapping entire parts, removing parts, or adding new parts altogether. By using relationships and parts, the open file format makes content easy to find and manipulate. The use of XML and XML schema means common XML technologies, such as XPath and XSLT, can be used to edit data within document parts in virtually endless ways.

One scenario might involve the need to edit text within many spreadsheet documents. For example, what if a company merged and needed to update their new company name in the cells of hundreds of different pieces of documentation? A developer could write code that loops through all the documents, locates the company name, and performs an XPath query to find the old text. Then new text may then be inserted and the process repeated until every document had been updated. Automation could save a lot of time, enable a process that might otherwise not be attempted, as well as prevent potential errors that might occur during a manual process.

Another scenario might be one in which an existing document must be updated by changing only an entire part. In a spreadsheet workbook, an entire worksheet that contained old data or outdated calculation models could be replaced with a new one by simply overwriting its part. This kind of updating also applies to binary parts. An existing image or even an OLE object could be swapped out for a new one, as necessary. A drawing embedded as an OLE object in a document, for instance, could be updated by overwriting that binary part. URLs in hyperlinks could be updated to point to new locations.

In order to optimize loading and saving performance and file size, a spreadsheet application may store only one copy of repetitive text within the spreadsheet file. The spreadsheet application may implement a shared string table. The shared string table may be stored in a document part such as “strings.xml.” Each unique text value found within a workbook may then only be listed once in this part of the document. Individual worksheet cells then reference the string table to derive their values.

So while this process optimizes the spreadsheet's XML file format, it also introduces some interesting opportunities for additional content manipulation solutions. Developers in a multinational organization could leverage the shared string table to offer a level of multilanguage support. Instead of building unique workbooks for each language supported, a single workbook could utilize string tables that correspond to different languages. Another possibility would be to use string tables to search for keyword terms inside a collection of workbooks. Processing a single, text-only XML file of strings is faster and simpler than having to manipulate the spreadsheet object model over many worksheets and workbooks.

The modularity of the open file format opens up the possibility for generating content once and then repurposing it in a number of other documents. A number of core templates could be created and used as building blocks for other documents. One example scenario is building a repository of images used in documents. A developer can create a solution that extracts images out of a collection of documents and allow users to reuse them from a single access point. Since the documents may store the images in their native format, the solution could build and maintain a library of images without much difficulty. A developer could build a similar application that reuses document “thumbnail” images extracted from documents, and add a visual aspect to a document management process.

Many organizations have vast collections of files that have reusable value. Finding, coordinating, and integrating (copying and pasting) the content, however, is typically a time-consuming, redundant process that many organizations look to automate. As illustrated in FIG. 3, each sheet within a workbook is a separate part that is readily accessible as each sheet is self-contained in its own XML part within the container. A custom solution can leverage this architecture to automate the assembly process. Custom XML could be used to hold metadata pertaining to individual sheets, thus allowing users to easily search them by using predefined keywords.

Like so many other aspects of documents using the open file format, document styles, formatting, and fonts are maintained in separate XML parts within the container package. Some organizations have very specific document standards, and managing these can be quite consuming. However, developers can, for example, modify or replace fonts in documents without opening the associated application.

Also, it is a fairly common practice to have a document or collection of documents that contain the same content, but that have been formatted differently by another department, location, subsidiary, targeted customer, or such. Developers can maintain the content within a single set of documents, and then apply a new set of styles, as necessary. To do this, they would exchange the styles part of the document found in a document with another part. This ability to exchange simplifies the process of controlling a document's presentation without having to manage content in numerous documents.

Managing documents effectively has been a long-standing issue in information technology practices. In the open file format, document properties are also readily accessible as they reside in their own part within a document. For example, a set of core properties may be stored and include items such as: title; subject; creator; keywords; description; modified by; revision; date created; date modified; and the like.

Organizations today cannot be confident that they will have access tomorrow to information locked in proprietary document formats, certainly if the program needed to properly display information in those documents is no longer available. Even for so-called “standards” based on proprietary page description languages (PDLs), the cumbersome presentation layer required by this information will make these formats difficult to sustain as an archival format.

Because the open file formats segment, store, and compress file components separately, they reduce the risk of corruption and improve the chances of recovering data from within damaged files. A cyclic redundancy check (CRC) error detection may be performed on each part within a document container to help ensure the part has not been corrupted. If one part has been corrupted, the remaining parts can still be used to open the remainder of the file. For example, a corrupt image or error in an embedded macro does not prevent users from opening the entire file, or from recovering the XML data and text-based information. Programs that utilize the open file format can easily deal with a missing or corrupt part by ignoring it and moving on to the next, so that any accessible data is salvaged. In addition, because the file formats are open and well documented, anyone can create tools for recovering parts that have been created improperly, for correcting XML parts that are not well formed, or for compensating when required elements are missing.

The open file format also addresses compatibility with both past file formats and future file formats that have not been anticipated. For example, a compatibility mode automatically restricts features and functionality that are unavailable in target versions help to ensure that users can exchange files seamlessly with other versions of an application or collaborate in mixed environments with no loss of fidelity or productivity.

Systems administrators may select the default file version type along with the default compatibility mode. Defaults can be set during installation or included in policies applied to specific users or specific roles. For example, organizations undertaking staged upgrades or staged rollouts might want to set a version 1 binary as the default “Save” option until all desktops have been upgraded.

The spreadsheet container 300 includes both user entered information as well as the feature and formatting information. Since the sheets are stored individually within a container it is easy to find a specific calculation result. Once the container 300 is opened and the desired file is accessed, there are a number of different ways to locate information. One way is by cell address and sheet name. Another method is by using an arbitrary schema for mapping data. Yet another method might be an end range. A set of XML vocabularies defined within the schemas included herein fully define the features for the spreadsheet application.

Workbooks, such as workbook 310, may be created without ever launching the spreadsheet application. For example, suppose that a customer of a Wall Street analyst company has access to information on certain companies. The customer accesses the analyst's website, logs on, and chooses to view the metrics for the evaluating a company in the automotive industry. The information returned could be streamed into a newly created workbook that was never touched by the spreadsheet application but which is now a spreadsheet file, such that when the customer selects the file, the spreadsheet application opens it up.

Each cell within a sheet may contain a variety of information. There is an address for the cell, there's potentially a formula, there's the contents of the cell, the data type of the cell (whether it's a string, number, etc.) and the like. Storing all of this information with each cell could potentially cause the performance of the spreadsheet application to become very sluggish. According to one embodiment, common information is stored within its own part. Some examples include, common strings, functions, and name ranges. For example, if a user highlights cells A-1 to A-10 and then names the range “Joe.” In this case, the name “Joe” is associated with cells A-1 to A-10. Storing this name with each cell results in redundant data. A more terse and performance enhanced way of storing the name stores the name range in a separate part, or a separate location outside of the cell definitions. For example, a single line could be that the name “Joe” stands from A-1 to A-10.” In one simple line the information is encapsulated as opposed to putting it ten different times on the cells A-1 through A-10.

Many spreadsheet objects have some kind of range as the source of the data that it's summarizing or operating on. For example, a chart can be hooked to a range that makes the bars go up and down. A pivot table can be hooked to a range. By breaking out each of the components the objects may be more easily accessed programmatically.

The open file format is designed such that previous and future versions of an application may still work with a document. A future storage area is included within a part such that information that has not been thought of yet may be included within a document. In this way, a future version of the spreadsheet application could access information within the future storage area, whereas a current version of the spreadsheet application does not. The future storage area resides in the schema, and the schema allows any kind of content to be in there. In this way, previous versions of an application may still appear to work without corrupting the values for the future versions.

Many characters that may be used within a spreadsheet application are not allowed in XML. If these characters are allowed to remain as it, the XML standard would be violated. Therefore, these special characters are encoded such that they may be saved out validly by XML (e.g. _xNNNN_ where N is a hex digit (0-9, A-F) . . . or some kind of hex based encoding). When the encoded character is encountered it may be detected and loaded appropriately.

Referring now to FIGS. 4A-4G, tables illustrating a document relationship hierarchy for various modular parts utilized in a file format 24 for representing a spreadsheet document are shown. Each table illustrated in FIGS. 4A-4G section represents a part in the file. The document relationship hierarchy illustrates lists specific file format relationships.

The various modular parts or components of the presentation hierarchy are logically separate but are associated by one or more relationships. Each modular part is also associated with a relationship type and is capable of being interrogated separately and understood with or without the spreadsheet application program 10 and/or with or without other modular parts being interrogated and/or understood. Thus, for example, it is easier to locate the contents of a document because instead of searching through all the binary records for document information, code can be written to easily inspect the relationships in a document and find the document parts effectively ignoring the other features and data in the open file format. Thus, the code is written to step through the document in a much simpler fashion than previous interrogation code. Therefore, an action such as removing all the code, personal information, and the like, while tedious in the past, is now less complicated.

A modular content framework may include a file format container associated with the modular parts. The modular parts include, the workbook part 420 operative as a guide for properties of the spreadsheet document. The document hierarchy may also include a document properties part containing built-in properties associated with the file format 24, a thumbnail part containing a thumbnail associated with the file format 24. It should be appreciated that each modular part is capable of being extracted from or copied from the document and reused in a different document along with associated modular parts identified by traversing relationships of the modular part reused. Associated modular parts are identified when the spreadsheet application 10 traverses inbound and outbound relationships of the modular part reused.

Aside from the use of relationships in tying parts together, there is also a single part in every file that describes the content types for each modular part. This gives a predictable place to query to find out what type of content is inside the file. While the relationship type describes how the parent part will use the target part, the content type 421 describes what the actual modular part is (such as “XML”) regarding content format. This assists both with finding content that is understood, as well as making it easier to quickly remove content that could be considered unwanted (for security reasons, etc.). The key to this is that the spreadsheet application must enforce that the declared content types are indeed correct. If the declared content types are not correct and do not match the actual content type or format of the modular part, the spreadsheet application should fail to open the modular part or file. Otherwise potentially malicious content could be opened. A comments part 420 may also be included.

Each table in FIGS. 4A-4G includes a content type 421, a relationship type 424, a ZIP Path/Part name 426 and a child parts (relationships section 428). The ZIP path 426 expresses the directory where the part resides within the zip archive. The child parts 428 expresses any child parts which the part may have.

As illustrated in FIG. 4A, workbook 420 may include many child parts at a book level, including, but not limited to: xlWorksheet (see 450); xlMacrosheet (see 454); xlDialogsheet (see 456); xlChartsheet (see 452); xlXmlMaps (see 468); xlStyles (see 460); xlSharedStrings (see 458); xlConnections (see 462); xlMetadata (see 484); xlVolatileDependencies (see 470); xlExternalReference (see 466); xlRevisionLog (see 472); xlUserNames (see 476); xlRevisionHeaders (see 474); xlQueryTable (see 497); xlPivotCacheDefinition (see 464); xlAttachedToolbars (see 478); xlCalcChain (see 480) and xlCustomProperty (see 482).

FIGS. 4B-4E illustrate exemplary tables for book level parts. FIG. 4F and FIG. 4G illustrate sheet level parts, including: xlPivotTable (see 490); xlTable (see 491); xlComments (see 492); xlPrinterSettings (see 493); xlBinarylndex (see 494); xlTableSingleCells (see 495); xllmage (see 496) and xlQueryTable (see 497). FIG. 4G also illustrates a sub sheet level part: xlPivotCacheRecords (see 498).

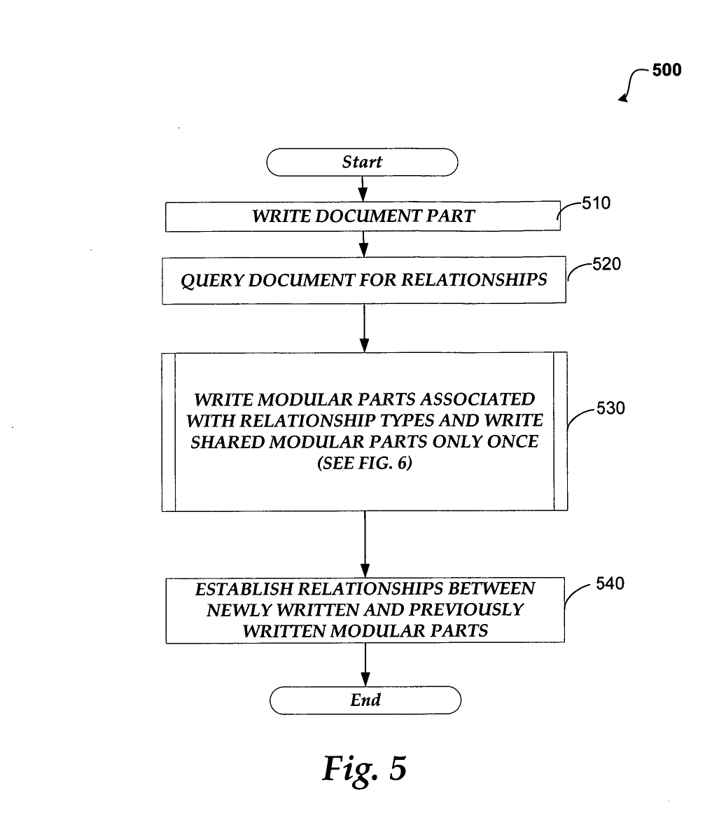

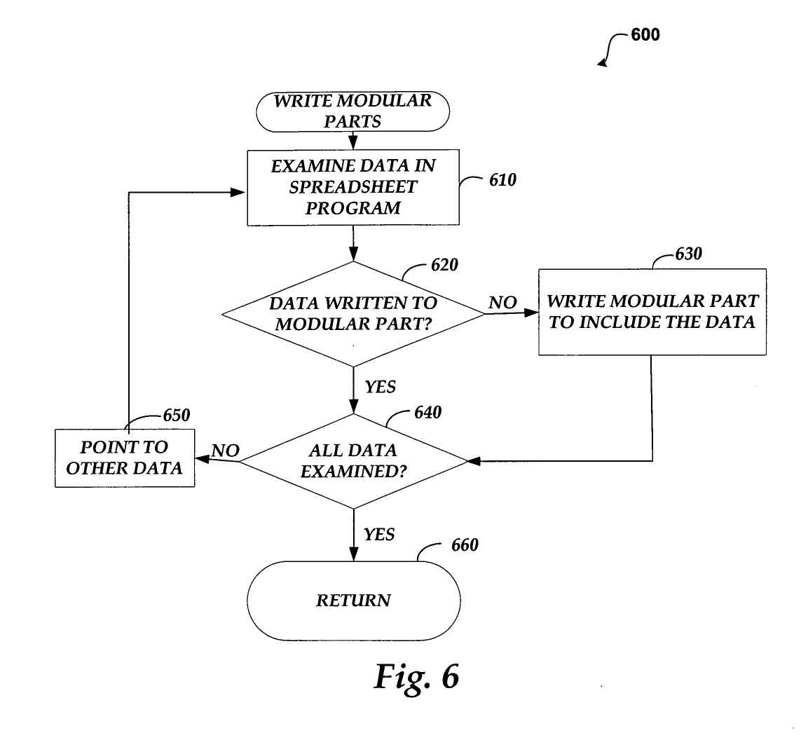

FIGS. 5-6 are illustrative routines performed in representing spreadsheet documents in a modular content framework. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations illustrated making up the embodiments described herein are referred to variously as operations, structural devices, acts or modules. These operations, structural devices, acts and modules may be implemented in software, in firmware, in special purpose digital logic, and any combination thereof.

Referring now to FIG. 5, the routine 500 begins at operation 510, where an application program, such as a spreadsheet application, writes a document part. The routine 500 continues from operation 510 to operation 520, where the application program queries the document for relationship types to be associated with modular parts logically separate from the document part but associated with the document part by one or more relationships. Next, at operation 530, the application writes modular parts of the file format separate from the document part. Each modular part is capable of being interrogated separately without other modular parts being interrogated and understood. According to one embodiment, any modular part to be shared between other modular parts is written only once. The routine 500 then continues to operation 540. At operation 540, the application 10 establishes relationships between newly written and previously written modular parts. The routine 500 then terminates at the end operation.

FIG. 6 illustrates a process for writing modular parts of a document. After a start operation, an application examines data in the spreadsheet application. The routine 600 then continues to detect operation 620 where a determination is made as to whether the data has been written to a modular part. When the data has not been written to a modular part, the routine 600 continues from detect operation 620 to operation 630 where the spreadsheet application writes a modular part including the data examined. The routine 600 then continues to detect operation 640.

When at detect operation 620, the data examined has been written to a modular part, the routine 600 continues from detect operation 620 to detect operation 640. At detect operation 640 a determination is made as to whether all the data has been examined. If all the data has been examined, the routine 600 returns control to other operations at return operation 660. When there is still more data to examine, the routine 600 continues from detect operation 640 to operation 650 where the spreadsheet application points to other data. The routine 600 then returns to operation 610 described above.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-readable medium having stored thereon an open file format for representing a document that is associated with a spreadsheet application, the open file format representing the document in a modular content framework implemented within a computing apparatus, comprising:
modular parts that are logically separate from one another but are associated by one or more relationships; wherein each modular part is associated with a relationship type and is capable of being interrogated separately without other modular parts being interrogated; and wherein the modular parts include:
a document properties part operative as a guide for properties of the document;
a sheet part for each sheet within a workbook; and
a markup language part that includes information for the modular parts.

2. The computer-readable medium of claim 1, wherein the modular content framework includes a container that encloses the modular parts within a single file.

3. The computer-readable medium of claim 2, wherein each modular part within the container is capable of being one of extracted from and copied from the document and reused in a different document along with associated modular parts identified by traversing relationships of the modular part reused.

4. The computer-readable medium of claim 3, wherein the modular parts further include a personal information part that may be removed for security reasons.

5. The computer-readable medium of claim 4, wherein the modular parts further include a user data part containing customized data capable of being read into the document.

6. The computer-readable medium of claim 4, wherein the modular parts further include at least one of the following: a code part that includes code associated with the document and a strings part that includes common strings.

7. The computer-readable medium of claim 4, wherein the functions part includes functions that are expressed as text and are associated with at least one sheet within a workbook.

8. The computer-readable medium of claim 3, where the relationship types associated with the modular parts comprises at least one of a code file relationship capable of identifying potentially harmful code files, a string relationship; a pivot table relationship; a user data relationship, a hyperlink relationship, a comments relationship, an embedded object relationship, a personal information relationship; a drawing object relationship, an image relationship, a document properties relationship, a thumbnail relationship, and a sheet relationship.

9. The computer-readable medium of claim 3, wherein the modular parts may include a future storage area such that previous versions of an application and future versions of the application may work without corrupting data.

10. The computer-readable medium of claim 9, wherein when content within a modular part is declared incorrectly, a spreadsheet application is configured to either fail to open the modular part or try to repair the modular part.

11. A computer-implemented method for representing a spreadsheet document in a file format wherein modular parts associated with the spreadsheet document include each part written into the file format, comprising:
writing sheet parts of the file format that are included within a workbook;
querying the spreadsheet document for relationship types to be associated with modular parts logically separate from the sheet parts but associated with the sheet parts by one or more relationships;
writing a second part of the file format separate from the sheet parts; and
establishing a relationship between the sheet parts and the second part;
wherein each of the spreadsheet parts and the second part may be interrogated individually.

12. The computer-implemented method of claim 11, further comprising: writing other modular parts associated with relationship types wherein the other modular parts that are to be shared are written only once; and establishing relationships to the other modular parts written.

13. The computer-implemented method of claim 12, wherein writing the other modular parts associated with the relationship types, comprises:
examining data associated with the document;
determining whether the data examined has been written to a modular part;
writing the modular part to include the data examined when the data examined has not been written to the modular part;
determining whether other data associated with the document has been examined; and
examining the other data associated with the document in response to determining that the other data has not been examined.

14. The computer-implemented method of claim 12, further comprising writing a shared strings part that includes common strings utilized within one or more the sheet parts.

15. The computer-implemented method of claim 14, further comprising: writing other modular parts associated with relationship types wherein the other modular parts that are to be shared are written only once; and establishing relationships to the other modular parts written.

16. The computer-implemented method of claim 13, further comprising ignoring the code from the document when the modular part is written.

17. The computer-implemented method of claim 13, further comprising stripping out personal information from the document before the modular part is written.

18. The computer-implemented method of claim 12, further comprising encapsulating the sheet parts and the second modular part within a container and storing the container as a single file.

19. The computer-implemented method of claim 13, further comprising validating the modular parts with an associated schema.

20. A computer program product comprising a computer-readable medium having control logic stored therein for causing a computer to represent a spreadsheet document in a file format comprising modular parts wherein the modular parts of the file format include each part written into the file format, the control logic comprising computer-readable program code for causing the computer to:
write a document part of the file format;
write a sheet part for each sheet within a workbook;
write a personal information part;
write a shared strings part;
write a code part; and
establish and write relationships between the parts.
